(19) United States
(12) Patent Application Publication
(10) Pub. No.: US 2019/0045045 A1
(43) Pub. Date: Feb. 7, 2019

(54) System for Managing Incoming Messages in Messaging Applications

(71) Applicants: Meir Dahan, Adi (IL); Eliahu Antopolsky, Zichron Yaakov (IL)

(72) Inventors: Meir Dahan, Adi (IL); Eliahu Antopolsky, Zichron Yaakov (IL)

(21) Appl. No.: 15/665,427

(22) Filed: Aug. 1, 2017

(51) Int. Cl. H04M 1/725; H04W 4/12

(52) U.S. Cl. CPC H04M 1/72547; H04M 2250/60; H04M 1/72566; H04W 4/12

(57) ABSTRACT

A system performed by a processing device running on a mobile device on which a messaging application is installed that enables the user to manage incoming messages. The user has the option to pre-determine time frame in which the incoming message will be noticeable on his mobile device. The system transmitting a notification to the mobile device of the sender of a message as to said time frame in which the message will be noticeable in the mobile device of the user and options to re-complete sending of the message in a way that it will be noticeable in that time frame or to re-complete the sending of the message in a way that it will be noticeable immediately.

### TECHNICAL FIELD

The present invention refers generally to a system that performed by processors running on mobile devices and or servers, which enables users to manage incoming messages in messaging applications on mobile devices.

### BACKGROUND ART

Many users download to their mobile devices messaging applications. The term “messaging applications” in this patent application refers to any kind of application for mobile devices that is designed to send and receive messages. Messages in messaging applications may include text messages, icons, photos, video and media files and the like (hereinafter “messages” or “a message”). Famous messaging applications are for example WhtasApp, Viber, Line, Facebook Messenger, Skype and the like. The messaging applications are usually downloaded to mobile devices, such as smartphones, tablet computers, wearable computers, etc.

In our days almost every mobile device includes one or more of messaging applications. In many cases the incoming messages distract the users' mind when they are focusing in their activities, such as, reading, writing, wondering, talking, cocking, working and the like. Many scientific studies have measured the bad effects of frequent distractions when a person is preoccupied with doing something or even at rest. For example, those studies show that such frequent distractions reduce a person's efficiency by about 20 IQ points and also harm his well-being and happiness. Regardless such harmful effects of frequent distractions it may be understood that many users wish to handle in real time only urgent important messages and to handle all other messages at a certain time convenient for them. To put the mobile device on mute mode or to close the messaging applications when the user wishes to be undistracted is not a good option, due to the fact that the average user is afraid to miss urgent important messages. The present invention offers a good and effective response to this problem.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a schematic diagram that shows the operation of the system that includes the mobile device of the user (3) with the smartphone application (1), the messaging application (2), the processing device (6) with the incoming message (4), and the mobile device of the sender (7) with the notification (7).

### THE INVENTION

The main object of the present patent application is to provide a system performed by processing devices that enables a user (hereinafter “the user”) of a messaging application that is installed on a mobile device and to a person who sends a message (hereinafter “the sender”) to said mobile device to determine whether the message will be noticeable in real time, means immediately following sending the message, or that the message will be noticeable on the mobile device of the user in a time frame that the user pre-determines. The term “noticeable” in this connection means that the mobile device of the user will alert in response to the incoming message and that the messaging application will present the message, basically in the normal way when the system is on no-active mode.

The system is performed by processing devices which includes computing devices. A smartphone application may be used as a framework for the overall operation of the system and for the sake of fluency we will use the term “smartphone application” hereinafter in this connection. Users of mobile devices can download the smartphone application to their mobile devices. The smartphone application performs the system on the processing devices in the mobile device or on processing devices of remote servers. For the sake of fluency the term “processing devices” in the mobile device includes also the processing devices on remote servers.

The smartphone application provides the user with an option to put the smartphone application on active mode or on no-active mode. The smartphone application communicates with the messaging applications on the mobile device. The smartphone application provides the user with an option to determine a time frame in which he will notice messages received to his messaging application on his mobile device, for example, between 16:00 to 19:00 or just at 16:00 and after. The smartphone application may include the option to set the time frame for one time, daily, weekly, or with no limits of time and until changing the settings. The time frame can be a period of time, for example between 16:00 to 19:00 for example, or even just “after 16:00 today”, “after 7 Aug. 2017” or “after 7 Aug. 2017 at 16:00”. For the sake of fluency we will use this time frame, 16:00 till 19:00 as an example along the present patent application.

When a person sends a message to the user of the mobile device that his smartphone application is on active mode and the time frame setting is between 16:00 to 19:00, as of our example, then the smartphone application will send to the mobile device of the sender and presents before the sender a notice that the user has chosen a time frame between 16:00 to 19:00 in which the message will be noticeable before the user (hereinafter “the notification”). The smartphone application provides before the sender the option to re-complete the sending of the message and that it will be noticeable in the time frame, at 16:00, and this option can be as a default, and an option to re-complete the sending of the message and that it will be noticeable immediately.

The notification includes the time frame and the smartphone application may provide the user with an option to select a notification out of several optional notifications and also the option to compose the notification by adding some information, as a text or symbols for example, that will be presented before the senders as to the matters, type of senders or specific senders that are requested or permitted to send their messages immediately as urgent messages.

For example, the user can compose the following notification: “Your message will be noticeable for me only today at 16:00; If your message is not urgent then press “send” and I will notice it at 16:00; if your message is urgent then press “urgent” and your message will be noticeable immediately; Any message regarding the school of my son, from my clients and from David or Sara—please send as “urgent”. We may assume that senders will act according the notification.

As a summary and for better explanation, the smartphone application includes the following characteristics: (a) Enables the user to activate and de-activate the smartphone application; (b) Enables the user to choose time frame, and may also enable the user to select notification or to compose one; (c) when the messaging application on the mobile device of the user receives a message and before presenting it before the user the smartphone application sends the notification to the sender and provides the sender with the option to re-complete the sending of the message in two or more options that includes: “send”, “urgent”, “cancel”; (d) when the sender presses on “send” then the message will be noticeable in the time frame; when pressing “urgent” then the message will be noticeable immediately; when pressing “cancel” then the sending of the message will be canceled.

The operation of the smartphone application includes communications done by the processing devices: (a) the smartphone application (1) that is downloaded on the mobile device of the user (3) communicates with the messaging applications (2) that are also downloaded on the mobile device of the user (3); (b) when the mobile device of the user (3) receives a message (4) from the mobile device of the sender (5) it may be stored in the processing device (6) in the mobile device of the user (3) and then the smartphone application (1) transmits the notification (7) to the mobile device of the sender (5); then, the sender may re-complete the sending of the message by pressing ‘send’, ‘urgent’ or ‘cancel’ and this re-completing command is transmitting from the mobile device of the sender (5) to the mobile device of the user (3); if the sender presses “send” then the message will be shown in the messaging application (2) in the time frame; if the sender presses ‘urgent’ then the messages will be shown in the messaging application (2) immediately; if the sender presses ‘cancel’ then the message will not be shown.

The smartphone application (1) and consequently the notification (7) may include the option that enables the sender to determine the time that the message (4) will be shown in the messaging application (2) and this time may be between the present moments to the time frame as notified in the notification. For example, the sender send the message at 08:00 and the time frame is between 16:00 to 19:00, so that if the sender thinks that the user should see the message no later than 12:30 then the sender can press on an option “when to be shown” and set the time “12:30”.

The smartphone application (1) do not block the possibility of the sender to send the message and do not block the possibility of the mobile device of the user (3) to receive the message (4) and even also to store it on the processing device (6) in the mobile device of the user (3). The smartphone application (1) leaves the decision to re-complete the sending of the message (4) to the sole discretion of the sender. The most important characteristic of the smartphone application (1) is that the user is not aware and is not distracted when a message received and stored in his mobile device waiting to be shown in the time frame that he set in advanced.

The smartphone application may be also useful in time of driving or having personal or business meetings. It is known that the average user is unlikely to closes the messaging applications in time of driving, due to unreasonable fear that he may miss important messages. In these cases, the user may psychologically allow himself to activate the smartphone application and to set the time frame according the anticipating time of the meeting or the driving. Many users unfortunately permit themselves to look at the mobile devices during driving when they hear the alert of incoming messages, which distract their mind and increase the risk of driving. In such cases, for example, before starting a driving for 2 hours between 10:00 to 12:00, the user may set the time frame as “after 12:00” and thus it is likely that he will receives fewer amounts of messages during driving for his safety.

It is possible that the messaging application itself will include the system as part of its characteristic built-in. In this case, the messaging application which is performed by the processing device that running on the mobile device enables the user to manage the incoming messages in the same manner as explained above and in the claims.

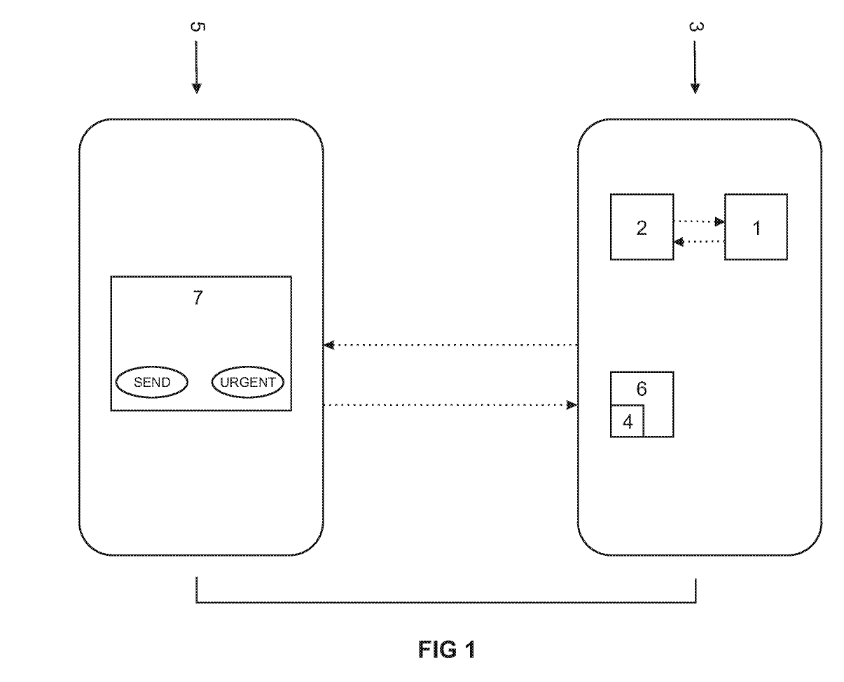

FIG. 1 is a schematic diagram that shows the operation of the system subject matter of the present invention that includes the mobile device of the user (3) with the smartphone application (1), the messaging application (2), the processing device (6) with the incoming message (4), and the mobile device of the sender (7) with a notification (7).

What is claimed is:

1. A system performed by a processing device running on a mobile device on which a messaging application is installed that enables a user of said mobile device to manage incoming messages in said messaging application, comprising:
providing to said user of said mobile device an option to put said system on active mode or on no-active mode;
providing to said user an option to pre-determine time frame in which said incoming messages will be noticeable on said mobile device of said user;
transmitting a notification to a mobile device of a sender of a message while said system is on active mode that notifying said sender as to said time frame in which said message will be noticeable in said mobile device of said user;
providing said sender with an option to re-complete sending of said message in a way that said message will be noticeable on said mobile device of said user in said time frame and an additional option to re-complete sending of said message in a way that said message will be noticeable immediately on said mobile device of said user;
whereby leaving to sole discretion of said sender whether to re-complete said sending of said message in a way that said message will be noticeable in said time frame or to re-complete said sending of said message in a way that said message will be noticeable immediately.

2. The system according to claim 1 further, enabling said user to select said notification out of two or more optional notifications.

3. The system according to claim 1 further, enabling said user to compose said notification.

4. The system according to claim 1 further, enabling said sender to determine the time in which said message will be noticeable on said mobile device of said user.

5. A messaging application performed by a processing device running on a mobile device that enables a user of said mobile device to manage incoming messages in said messaging application, comprising:
providing to said user an option to pre-determine time frame in which said incoming messages will be noticeable on said mobile device of said user;
transmitting a notification to a mobile device of a sender of a message while said system is on active mode that notifying said sender as to said time frame in which said message will be noticeable in said mobile device of said user;
providing said sender with an option to re-complete sending of said message in a way that said message will be noticeable on said mobile device of said user in said time frame and an option to re-complete sending of said message in a way that said message will be noticeable immediately on said mobile device of said user;
whereby leaving to sole discretion of said sender whether to re-complete said sending of said message in a way that said message will be noticeable in said time frame or to re-complete said sending of said message in a way that said message will be noticeable immediately.

6. The messaging application according to claim 5 further, enabling said user to select said notification out of two or more optional notifications.

7. The messaging application according to claim 5 further, enabling said user to compose said notification.

8. The messaging application according to claim 5 further, enabling said sender to determine the time in which said message will be noticeable on said mobile device of said user.
